(19) United States
(12) Patent Application Publication
(10) Pub. No.: US 2004/0139039 A1
(43) Pub. Date: Jul. 15, 2004

(54) Distributed fuzzy logic target signal discriminator for collision avoidance laser radar

(76) Inventor: Yi-Jen Mon, Taoyuan Hsein (TW)

Correspondence Address: JOHNSON & ASSOCIATES PC, 14625 BALTIMORE AVENUE #282, LAUREL, MD, 20707, US

(21) Appl. No.: 10/342,386

(22) Filed: Jan. 15, 2003

(51) Int. Cl. G06F 15/18; G06F 17/10; G06G 7/78; G01S 1/00

(52) U.S. Cl. 706/1; 701/301

(57) ABSTRACT

A distributed fuzzy logic target signal discriminator for collision avoidance laser radar comprising a delayer, a subtractor, an arbitration module, a fuzzy logic inference module and an output module; the present invention uses fuzzy logic to design an adjustable tolerance bound δ(t) for stabilizing signals. The fuzzy model is a Takagi-Sugeno type and the inference method is fuzzy inference.

### BACKGROUND OF THE INVENTION

1. Field of the Invention

The present invention relates to a distributed fuzzy logic target signal discriminator for collision avoidance laser radar. More specifically the present invention relates to the application of a distributed fuzzy logic target signal discriminator for collision avoidance laser radar of vehicles.

2. Description of Related Art

In recent years researchers have focused on studying vehicles collision avoidance system design. For instance, U.S. Pat. No. 5,621,514 uses optical heterodyne method to calculate the reflection time of optical pulse signal and obtained its relative distance, and used Doppler analysis circuit to calculate the target vehicles relative velocity. U.S. Pat. No. 5,510,922 used synchronous detection circuit design to modulate the transmitted frequency of optical source to an optimal value and obtained a stabilized range value. U.S. Pat. No. 5,471,214 used laser radar transceiver as an auxiliary equipment to determine a secure distance, to discriminate any obstacle within the transceiver range, and to incorporate a non-laser radar sensor device, a target intrusion sensor capable of prompting danger alert. U.S. Pat. No. 5,529,138 used two sets of laser radar to detect the obstacle and calculate the angle difference between the transmitted and received signals to arbitrate the existence of obstacle. U.S. Pat. No. 2,983,161 used global positioning system (GPS) for assistance and incorporated various sensor to analyze road condition and alerted danger to avoid collision. Taiwan patent number 446651 used fuzzy logic to form a mechanism to arbitrate secure distance for collision avoidance.

Among the aforementioned prior arts documents, U.S. Pat. Nos. 5,621,514, 5,510,922, 5,471,214 and 5,529,138 all used a method of circuit design to stabilize the frequency or phase of the signal, but on the other hand there is a burden of power consumption and complexity of the circuit, and the requirement of environmental noise rejection is much higher. U.S. Pat. No. 5,983,161 and Taiwan patent 446651 are based on the assumption that the received range signals are stable and the collision avoidance system is based on this stability. Nevertheless, this method required the measured relative range and velocity of the vehicle in possession of the system and the vehicle in front of it to input the measured values into a secure distance arbitrator for calculation and determination of the optimal condition for the owned car to avoid collision. In fact, the actual measurement of the signal does not appear to be completely stable, and thus the arbitrated result would be affected.

### SUMMARY OF THE INVENTION

An object of the present invention is to provide a distributed fuzzy logic target signal discriminator for collision avoidance laser radar comprising a delayer, a subtractor, an arbitration module, a fuzzy logic inference module and an output module.

Another object of the present invention is to use fuzzy logic to design an adjustable tolerance bound for stabilizing signals; the fuzzy model is a Takagi-Sugeno type and the inference method is fuzzy inference.

Still another object of the present invention is to provide a distributed fuzzy logic target signal discriminator system for collision avoidance laser radar comprising a laser radar signal reflected signal receiver, a signal amplifier, a analog to digital converter, a distributed fuzzy logic signal discriminator and a secure distance arbitrator.

Still further, another object of the present invention is to provide distributed fuzzy logic target signal discriminator capable of reducing circuit complexity to improve stability and accuracy of distance measurements while solving the problems associated with the related prior art algorithm design of their collision avoidance system which does not consider the signal stability.

Still further another object of this present invention is to have a fuzzy logic robust in signal interference and is capable of establishing a knowledge library of human perceptibility, thus enhancing the capacity to stand off the signal interference, and yet when there is a need to modify the library containing the fuzzy rules due to changes in the environment and the use of different vehicles, this invention is capable of accomplishing the latter much quicker than the prior art at a reduce cost.

The present invention will be readily apparent upon reading the following description of a preferred exemplified embodiment of the invention and upon reference to the accompanying drawings.

### BRIEF DESCRIPTION OF THE DRAWINGS

FIG. 1 is a block diagram of the distributed fuzzy logic target signal discriminator system of the present invention.

FIG. 2 is a signal timing algorithm of the distributed fuzzy logic target signal discriminator of the present invention.

FIG. 3 is a fuzzy attribute function diagram of the distributed fuzzy logic target signal discriminator of the present invention.

FIG. 4 is a design flow chart of the distributed fuzzy logic target signal discriminator of the present invention.

FIG. 5 is a simulation test result of 20 m distance between two vehicles with the distributed fuzzy logic target signal discriminator of the present invention.

FIG. 6 is a simulation test result of 30 m distance between two vehicles with the distributed fuzzy logic target signal discriminator of the present invention.

FIG. 7 is a simulation test result of 40 m distance between two vehicles with the distributed fuzzy logic target signal discriminator of the present invention.

FIG. 8 is a simulation test of 50 m distance between two vehicles with the distributed fuzzy logic target signal discriminator of the present invention; and,

FIG. 9 is a simulation test of 20 m distance between two vehicles with IIR filter.

### DETAILED DESCRIPTION AND PREFFERED EMBODIMENT

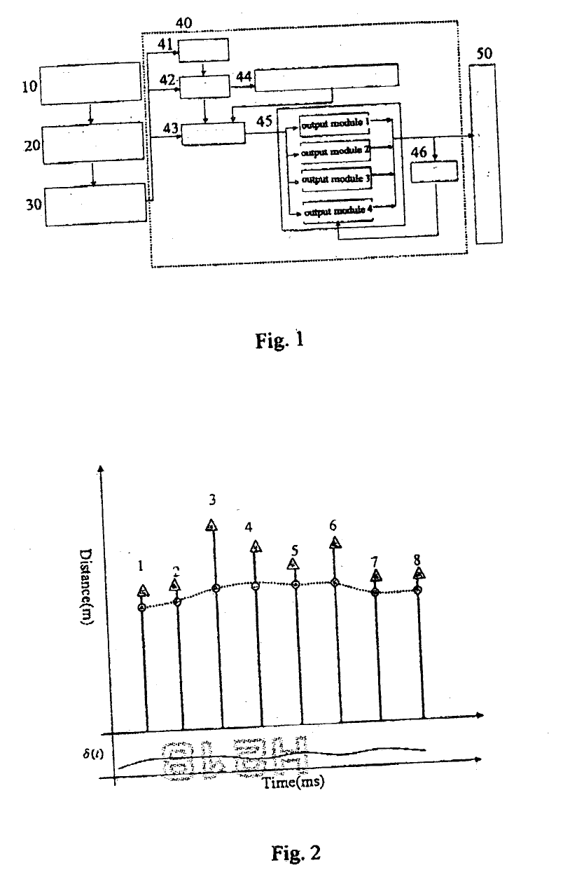

With reference to FIG. 1, the distributed fuzzy logic target signal discriminator of the present invention includes a laser radar reflected signal receiver 10, a signal amplifier and counter circuit 20, aN analog to digital (A/D) converter 30, a distributed fuzzy target signal discriminator 40, and a secure distance arbitrator 50, wherein said distributed fuzzy target signal discriminator 40 consist of a delayer 41, a subtractor 42, a arbitration module 43, a fuzzy logic inference module 44, an output module 45 and a delayer 46. The output module 45 further consist of an output module 1,output module 2, output module 3 and output module 4.

During application of the vehicles collision avoidance system, if the system uses Doppler radar for speed detection, the system's ability to discriminate amongst object is somewhat limited. This is because the Doppler radar microwave has a wide beam width, which results in a larger divergent angle during distance measurement. Therefore the present invention uses laser radar for object discrimination. Some advantages of using laser radar are (1) shorter wave length and (2) narrower wave beam width, which is suitable for front scanning. Laser radar also has better discriminatory capabilities and is suitable for use in the field of vehicle collision avoidance system.

FIG. 1 illustrates the basic operational principle of the present invention. A laser diode transmits laser pulses which hit the target vehicle, and the reflected signal is received by the laser radar reflected signal receiver 10 to detect the time difference between transmitting and receiving of signals. These signals after being processed by a signal amplifier and a counter circuit 20 can be converted to distance signals, and then converted from analog signals to digital signals through A/D converter 30 to output digital values to succeeding stages of the distributed fuzzy logic target signal discriminator 40 for calculation.

When digital values are outputted to succeeding stages of the distributed fuzzy logic signal discriminator 40 for calculation, the digital signals encounter a digital hopping problem. The manner in which this problem is solved is illustrated in FIG. 2. Referring to FIG. 2, is an illustration of a signal timing algorithm of the distributed fuzzy logic target signal discriminator of the present invention. FIG. 2 shows eight signal points, which indicates different reflected signals that the radar may receive due to different object reflection surfaces. For instance, starting signal 1 represents the received reflected signal and among these eight signals there are signal points 3, 4, 5 and 6 possibly representing incorrect signals reflected back from various vehicles. Thus, how to correctly retrieve signal points 1, 2 and 7 for distance values becomes very important for the front end process unit, otherwise the secure distance arbitrator 50 in the back end is unable to provide any assistance.

The distributed fuzzy logic target signal discriminator 40 of the present invention solves the aforementioned flaws by using the robust fuzzy logic to recover signal interference and to establish a knowledge library based on the rules of human perceptibility. The distributed fuzzy logic target signal discriminator 40 of the present invention uses fuzzy logic concepts to design an adjustable tolerance bound δ(t) for stabilizing signals. First of all, the signal points in the process are compared with the preceded signal point to obtain a trembling quantity, which is compared with δ(t) (as shown in the lower part of FIG. 2). If the trembling quantity is more than δ(t), it means that the signal stability has more weight than its sensitivity, and will maintain more portion of the preceded output value. On the contrary, if the trembling quantity is less than δ(t), it means that the signal sensitivity has more weight than its stability and it will maintain more portion of the current output value. The result of calculation is indicated by the circular dots as shown in the upper part of FIG. 2.

Referring to FIG. 1, the Delayer 41 of the distributed fuzzy logic target signal discriminator 40, delays laser radar reflected noise input signal xᵢₙ(t), a sampling time interval, to obtain a preceded input signal xᵢₙ(t−1), meanwhile delaying the output signal out(t), a sampling time interval, to obtain a preceded output signal out(t−1). The Subtractot 42, also of the distributed fuzzy logic target signal discriminator is a circuit use to calculate an absolute value error between laser radar reflected noise input signal xᵢₙ(t) and the preceded input signal xᵢₙ(t−1) for use in the arbitration module 43 and the fuzzy logic inference module 44.

Again, referring to FIG. 1, the arbitration module 43 of the distributed fuzzy logic target signal discriminator 40 retrieves laser radar reflected noise input signal xᵢₙ(t), conducts initial arbitration operation, selects the output module to output signal, and provides a trigger weighed value required by the distributed parallel-distributed-compensation (PDC) of the fuzzy logic inference module 44. Because the reflected signals are mixed with many unnecessary non-noise signals, these non-noise signals are the error signals caused by the object non-plane surface or environmental feedback signal during the scanning operation of the laser radar.

The arbitration module is based on two factors: first, the absolute value of error |xᵢₙ(t)−xᵢₙ(t−1)| difference between the current time interval signal and the preceded time interval signal of subtractor 42. The second is the tolerance error bound δ(t) of the fuzzy logic inference module. Furthermore under different conditions, the signal tolerable upper limit and lower limit can be set off-line. When the signal is higher than the tolerable upper limit or lower than tolerable lower limit, it is allowed to enter counter, and if the occurrence times are within a reasonable value, it means noise existed in the signal and the original signal are outputted, otherwise, it means the signal is a validated upper limit value or lower limit value. If the input signal is between upper limit and lower limit then it enters another arbitration process.

The arbitration process is performed based on the relationship |xᵢₙ(t)−xᵢₙ(t−1)| and δ(t). When

|xᵢₙ(t)−xᵢₙ(t−1)|≧δ(t) (1)

is satisfied, this means the variation is too large, and thus the output signal will maintain a significant portion of the preceded signal. The scale of portion depends on the product of the weight w₂ of |xᵢₙ(t)−xᵢₙ(t−1)| and xᵢₙ(t−1), and as for xᵢₙ(t) the weight w₁ will still be maintained. When

|xᵢₙ(t)−xᵢₙ(t−1)|<δ(t) (2)

means the variation is within the tolerable error limit δ(t), and the current output will maintain a lesser portion of the preceded signal. The scale of the lesser portion depends on w₄ of xᵢₙ(t−1), and as for xᵢₙ(t), the weight w₃ will still be maintained. When the ratio of the weight is represented as

$$k = \frac{{w}_{3}}{{w}_{4}} \qquad ( 3 )$$

the response speed of signal may be affected. the larger the value of k, the faster the response and vice versa. The best ratio weight value is represented as

1≦k≦2. (4)

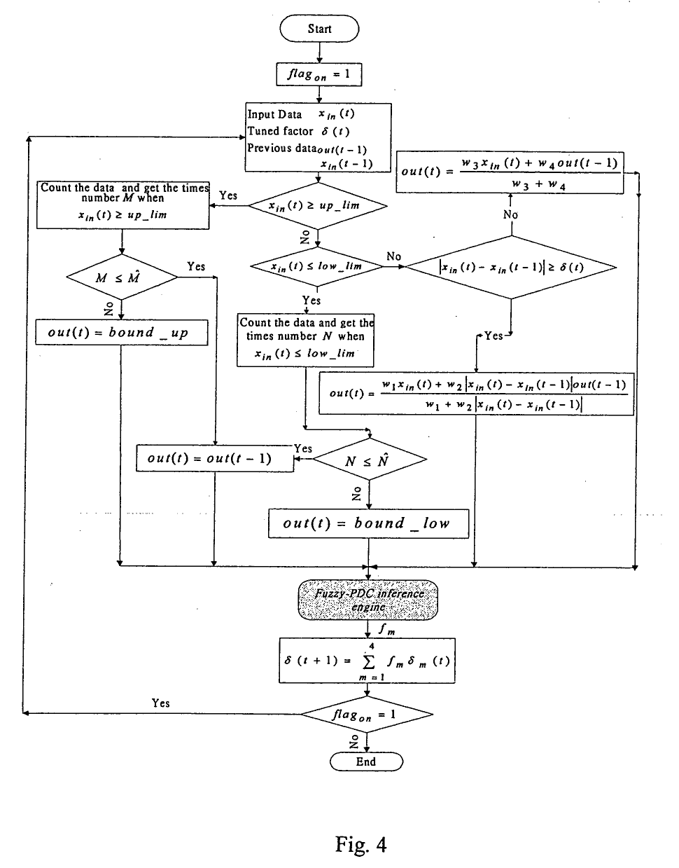

FIG. 4 shows a design flow chart of the distributed fuzzy logic target signal discriminator 40 of the present invention illustrating a main technical characteristics of the invention—the fuzzy logic inference 44.

Referring to FIG. 4, the fuzzy input is |xᵢₙ(t)−xᵢₙ(t−1)| and the fuzzy model used is a Takagi-Sugeno type and the inference method is fuzzy inference 44 shown in FIG. 1, the system design of the present invention has an output module 45 consisting of four output modules (output module 1,output module 2, output module 3 and output module 4). Each module is capable of outputting its individual distance value and at the same time providing its individual tolerable error bound δₙ(t) (where n=1,2,3,4) to the fuzzy inference input so as to allow the fuzzy logic inference module at the time the arbitration module output a signal to infer a reasonable tolerable error bound δ(t+1) for the next time. In order to simplify the design, the fuzzy attribute function adopted trigonometry with slope rate of ±1, and there are four fuzzy rules as:

Rule 1: if |xᵢₙ(t)−xᵢₙ(t−1)| is very small, then \hat{δ}(t+1)=δ₁(t)

Rule 2: if |xᵢₙ(t)−xᵢₙ(t−1)| is small, then \hat{δ}(t+1)=δ₂(t)

Rule 3: if |xᵢₙ(t)−xᵢₙ(t−1)| is large, then \hat{δ}(t+1)=δ₃(t)

Rule 4: if |xᵢₙ(t)−xᵢₙ(t−1)| is very large, then \hat{δ}(t+1)=δ₄(t)

Where for δₙ(t) n=1,2,3,4 indicates its individual n-th output module δ(t), and the final result of module inference is

$$δ ( t + 1 ) = \frac{{\sum }_{m = 1}^{4} {f}_{m} {δ}_{m} ( t )}{{\sum }_{m = 1}^{4} {f}_{m}} \qquad ( 5 )$$

where fₘ m=1,2,3,4 represents trigger weight value of the fuzzy attribute function.

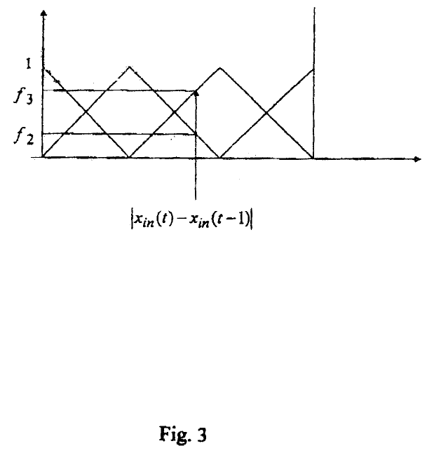

Now referring to FIG. 3, is shown a fuzzy attribute function diagram of the distributed fuzzy logic target signal discriminator of the present invention. The attribute function uses slope rate equalling ±1, thus

$${\sum }_{m = 1}^{4} {f}_{m} = 1. \qquad ( 6 )$$

Therefore Eq. (5) becomes

$$δ ( t + 1 ) = {\sum }_{m = 1}^{4} {f}_{m} {δ}_{m} ( t ) . \qquad ( 7 )$$

FIG. 4 shows a design flow chart of the distributed fuzzy logic target signal discriminator 40 of the present invention based on the algorithm of the arbitration module. The output module 5 of the distributed fuzzy logic target signal discriminator 40 consist of four output modules (output module 1,output module 2, output module 3 and output module 4). These four-output module output the following distance values:

1. First module (module 1): when the signal is within the tolerable upper limit or lower limit, and the signal is outside the tolerable error bound; then from eq. (1) the output is represented as

$$out ( t ) = \frac{{w}_{1} {x}_{i n} ( t ) + {w}_{2} \vert {x}_{i n} ( t ) - {x}_{i n} ( t - 1 ) \vert out ( t - 1 )}{{w}_{1} + {w}_{2} \vert {x}_{i n} ( t ) - {x}_{i n} ( t - 1 ) \vert} \qquad ( 8 )$$

2. Second module (module 2): when the signal is within the tolerable upper limit or lower limit, and the signal is inside the tolerable error bound δ(t); then from eq. (2) the output is represented as

$$out ( t ) = \frac{{w}_{3} {x}_{i n} ( t ) + {w}_{4} out ( t - 1 )}{{w}_{3} + {w}_{4}} \qquad ( 9 )$$

3. Third module (module 3): when the signal is outside the tolerable upper limit or lower limit and reaches above a constant time data count; then outputs an upper limit or a lower limit value as

out(t)=bound_{—}low (10)

or

out(t)=bound_{—up} (11)

4. Fourth module (module 4): when the signal is outside the tolerable upper limit or lower limit but is not within a constant time data count; then output a preceding outputted value represented as:

out(t)=out(t−1) (12)

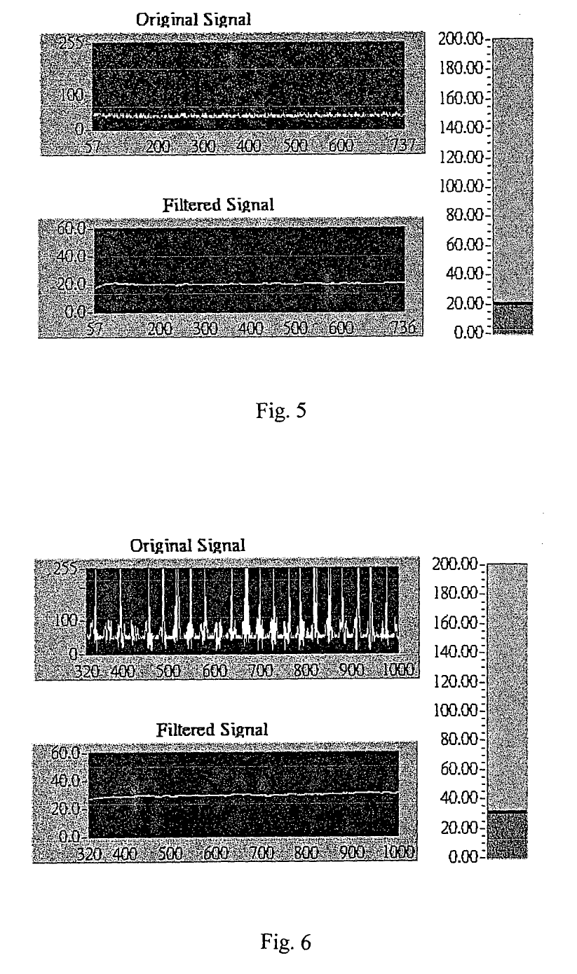

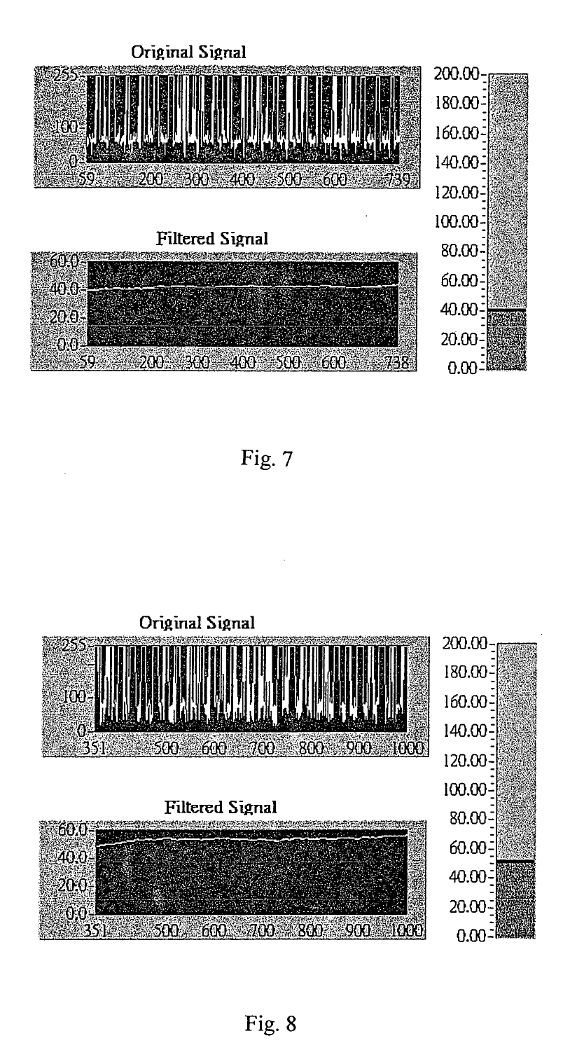

In order to prove that the distributed fuzzy logic target signal discriminator of the present invention is an advanced design, the inventor used LabView™ application to retrieve external signals and recorded the measurement for further simulation test. The measured distances were for four set of distances at 20 m, 30 m, 40 m and 50 m and simulation results are shown in FIG. 5 to FIG. 8. In each figure the upper part represents the unprocessed signals showing hopping phenomena and the lower parts in each figure represents the processed signals by the distributed fuzzy logic target signal discriminator of the invention. As shown in the figures, the hopping phenomena was tremendously improved and simulation results showed that the accuracy did satisfy the requirements for the vehicle collision avoidance system design and the signal is good enough to provide for use in the secure distance arbitrator.

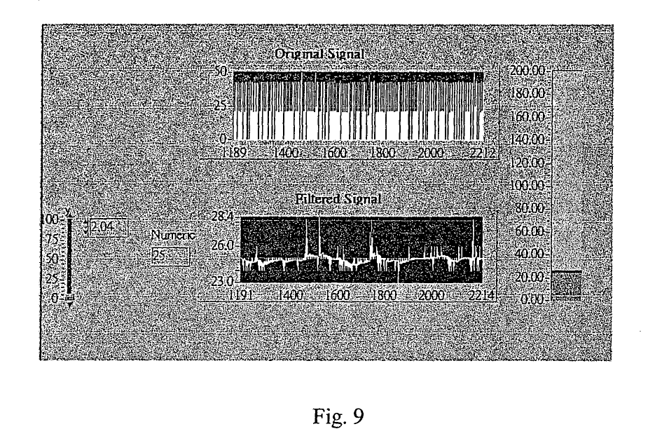

In FIG. 9, as shown is a simulation test of 20 m in distance between two vehicles with a general use IIR filter. This experiment used a scale-6 IIR filter and experienced hopping cutoff frequency needed at different distance values. In other words, when the correct signal amount is less than the incorrect signal and the occurred incorrect signal is not stable in the spectrum, then obviously it is not a proper time to use a filter.

Various additional modification of the embodiments specifically illustrated and described herein will be apparent to those skilled in the art in light of the teachings of this invention. The invention should not be construed as limited to the specific form and examples as shown and described. The invention is set forth in the following claims.

What is claimed is:

1. A distributed fuzzy logic target signal discriminator for collision avoidance laser radar, which uses fuzzy logic to design an adjustable tolerance bound for stabilizing signals comprising a delayer, a subtractor, an arbitration module; wherein said fuzzy model is a Takagi-Sugeno type; and an inference fuzzy method comprising Equations (5) to (7) of the specification.

2. The discriminator in claim 1, wherein the output module consisted of four output modules: output module 1, output module 2, output module 3 and output module 4.

3. The discriminator as in claim 2, wherein the signal is within a tolerable upper limit or lower limit; and where the signal is outside the tolerable error bound, the output is
$$out ( t ) = \frac{{w}_{1} {x}_{i n} ( t ) + {w}_{2} \vert {x}_{i n} ( t ) - {x}_{i n} ( t - 1 ) \vert out ( t - 1 )}{{w}_{1} + {w}_{2} \vert {x}_{i n} ( t ) - {x}_{i n} ( t - 1 ) \vert} . \qquad ( 13 )$$

4. The discriminator as in claim 2, wherein when the signal is within the tolerable upper limit or lower limit, and the signal is inside the tolerable error bound δ(t), the output is
$$out ( t ) = \frac{{w}_{3} {x}_{i n} ( t ) + {w}_{4} out ( t - 1 )}{{w}_{3} + {w}_{4}} . \qquad ( 14 )$$

5. The discriminator as in claim 2, wherein when the signal is outside the tolerable upper limit or lower limit, and reaches above a constant time data count then outputs a upper limit or a lower limit value as
out(t)=bound_{—low} (15)
or
out(t)=bound_{—up.} (16)

6. The discriminator as in claim 2, wherein when the signal is outside the tolerable upper limit or lower limit, but has not reached within a constant time data count then output the preceding outputted value as
out(t)=out(t−1). (17)

7. The discriminator as in claim 1, wherein said delayer is to delay laser radar reflected noise input signal xᵢₙ(t), a sampling time interval, to obtain a preceded input signal xᵢₙ(t−1).

8. The discriminator as in claim 1, wherein said delayer is to delay the output signal out(t), a sampling time, interval to obtain a preceded output signal out(t−1).

9. The discriminator as in claim 1, wherein said subtractor is to calculate an absolute error value between laser radar reflected noise input signal xᵢₙ(t) and the preceded input signal xᵢₙ(t−1).

10. The discriminator as in claim 1, wherein said arbitration module is to retrieve laser radar reflected noise input signal xᵢₙ(t) to proceed initial arbitration operation, and then selected the output module to output signal.

11. The discriminator as in claim 1, wherein said arbitration module is to provide a trigger weigh value required by the distributed parallel-distributed-compensation (PDC) to the fuzzy logic inference module.

12. The discriminator as in claim 1, wherein said arbitration module is based on an absolute error value |xᵢₙ(t)−xᵢₙ(t−1)|; the difference between the current time interval signal and the preceded time interval signal of the subtractor.

13. The discriminator as in claim 1, wherein said arbitration module is based on the tolerance error bound δ(t) of the fuzzy logic inference module.
